(19) United States
(12) Patent Application Publication
(10) Pub. No.: US 2025/0266707 A1
(43) Pub. Date: Aug. 21, 2025

(54) CHARGING CONTROL SYSTEM AND CHARGING CONTROL DEVICE

(71) Applicant: NINTENDO CO., LTD., Kyoto-shi (JP)

(72) Inventor: Kohei MATSUMOTO, Kyoto-shi (JP)

(21) Appl. No.: 19/186,324

(22) Filed: Apr. 22, 2025

Related U.S. Application Data
(63) Continuation of application No. PCT/JP2022/040466, filed on Oct. 28, 2022.

(51) Int. Cl. H02J 7/34; A63F 13/92; H02J 7/00

(52) U.S. Cl. CPC H02J 7/342; H02J 7/00032; H02J 7/0019; H02J 7/0048; H02J 7/007182; H02J 7/007194; A63F 13/92

(57) ABSTRACT

A charging control system is provided. A first apparatus includes a first battery, a first power supply manager, a first switch for connecting/disconnecting between a first terminal and the first battery, in accordance with a command from the first power supply manager, and a first resistor provided between the first battery and the first terminal. A second apparatus includes a second battery, a second power supply manager, a second switch for connecting/disconnecting between a second terminal and the second battery, in accordance with a command from the second power supply manager, and a second resistor provided between the second battery and the second terminal. When the first apparatus and the second apparatus are coupled to each other, the first battery and the second battery are electrically connected to each other with the first resistor, the first switch, the second switch, and the second resistor connected in series being interposed.

This non-provisional application claims priority on and is a continuation of International Patent Application PCT/J P2022/040466 filed with the Japan Patent Office on Oct. 28, 2022, the entire contents of which are hereby incorporated by reference.

### FIELD

The present disclosure relates to a charging control system and a charging control device.

### BACKGROUND AND SUMMARY

A charging control device that causes charging, with electric power in a first battery included in a first apparatus, of a second battery included in a second apparatus has been known. This charging control device includes a control unit provided in the first apparatus, the control unit controlling an amount of charging electricity to be supplied from the first battery to the second apparatus based on information on a remaining battery level of the second battery and information on power consumption in the second apparatus which have been supplied from the second apparatus.

In transfer of electric power between batteries, electric power and a current are generally adjusted by a charging control circuit such as a charging control integrated circuit (IC). Overall power feed performance, on the other hand, may lower because there may be conversion loss in the charging control IC. In the prior art, only charging in one direction is assumed and mutual power feed is not assumed.

An exemplary embodiment provides a charging control system that includes a first apparatus and a second apparatus separable from each other. The first apparatus includes a first battery, a first power supply manager, a first switch for connecting or disconnecting between a first terminal for electrical connection to the second apparatus and the first battery, in accordance with a command from the first power supply manager, and a first resistor provided between the first battery and the first terminal. The second apparatus includes a second battery, a second power supply manager, a second switch for connecting or disconnecting between a second terminal for electrical connection to the first apparatus and the second battery, in accordance with a command from the second power supply manager, and a second resistor provided between the second battery and the second terminal. When the first apparatus and the second apparatus are coupled to each other, the first battery and the second battery are electrically connected to each other with the first resistor, the first switch, the second switch, and the second resistor connected in series being interposed.

According to this configuration, the first battery and the second battery are electrically connected to each other with the switch and the resistor being interposed. Therefore, mutual charging can be performed in accordance with states of the first battery and the second battery, and overall efficiency of power feed can be enhanced.

Power feed from the first battery to the second battery or power feed from the second battery to the first battery may occur in accordance with at least one of (i) a voltage of the first battery and a voltage of the second battery or (ii) a remaining battery level of the first battery and a remaining battery level of the second battery. According to this configuration, a direction of power feed is determined by voltages or remaining battery levels of the first battery and the second battery, and hence a charging control circuit or the like is not required.

At least one of when the voltage of the first battery is higher than the voltage of the second battery or when the remaining battery level of the first battery is higher than the remaining battery level of the second battery, power feed from the first battery to the second battery may occur. At least one of when the voltage of the second battery is higher than the voltage of the first battery or when the remaining battery level of the second battery is higher than the remaining battery level of the first battery, power feed from the second battery to the first battery may occur. According to this configuration, power feed occurs from a battery higher in voltage or remaining battery level to a battery lower in voltage or remaining battery level. Therefore, the first apparatus and the second apparatus can continue processing while they interchange electric power.

When the first apparatus and the second apparatus are coupled to each other, in a path through which the first battery and the second battery are electrically connected to each other, a charging control circuit for power feed from the first battery to the second battery and a charging control circuit for power feed from the second battery to the first battery do not have to be provided. According to this configuration, there is no electric power loss in the charging control circuit.

The first power supply manager may cause the first switch to connect or disconnect based on at least one of a voltage or a temperature of the first battery. The second power supply manager may cause the second switch to connect or disconnect based on at least one of a voltage or a temperature of the second battery. According to this configuration, each of the first power supply manager and the second power supply manager can perform mutual power feed while it manages the voltage and/or the temperature of the battery.

At least one of the first power supply manager or the second power supply manager may transmit at least one of a voltage or a temperature of the battery of the apparatus to which the first power supply manager or the second power supply manager belongs, to another one of the first power supply manager and the second power supply manager. At least one of the first power supply manager or the second power supply manager may cause the switch of the apparatus to which the first power supply manager or the second power supply manager belongs, to connect or disconnect based on at least one of the voltage or the temperature of the battery obtained from the another one of the first power supply manager and the second power supply manager. According to this configuration, the first power supply manager and/or the second power supply manager can determine whether or not to perform mutual power feed between batteries of the apparatuses to which they belong, based on information on the other of the power supply managers.

The first power supply manager may command the first switch to connect when a voltage of the first battery is within a predetermined voltage range. The second power supply manager may command the second switch to connect when a voltage of the second battery is within a predetermined voltage range. According to this configuration, mutual power feed can be performed only when the voltage of the battery is within the predetermined voltage range, and hence the battery is not damaged.

The charging control system may further include a third apparatus configured to be coupled to at least one of the first apparatus or the second apparatus. The third apparatus may include a third battery, a third power supply manager, a third switch for connecting or disconnecting between a third terminal for electrical connection to at least one of the first apparatus or the second apparatus and the third battery, in accordance with a command from the third power supply manager, and a third resistor provided between the third battery and the first terminal. When the first apparatus, the second apparatus, and the third apparatus are coupled to one another, the third battery may be connected between the first switch and the second switch, with the third switch and the third resistor being interposed. According to this configuration, mutual power feed can be performed among three apparatuses.

Power feed may occur among the first battery, the second battery, and the third battery in accordance with at least one of (i) voltages of the first battery, the second battery, and the third battery or (ii) remaining battery levels of the first battery, the second battery, and the third battery. According to this configuration, the direction of power feed is determined by the voltages or the remaining battery levels of the first battery, the second battery, and the third battery, and hence a charging control circuit or the like is not required.

The first apparatus may be an electronic device including a display. The second apparatus may be a controller to be coupled to one side of the first apparatus and configured to transmit a signal in accordance with an operation by a user to the first apparatus. The third apparatus may be a controller to be coupled to the other side of the first apparatus and configured to transmit a signal in accordance with an operation by the user to the first apparatus. At least one of when a voltage of the first battery is higher than a voltage of the second battery and a voltage of the third battery or when a remaining battery level of the first battery is higher than a remaining battery level of the second battery and a remaining battery level of the third battery, power feed from the first battery to the second battery and the third battery may occur. At least one of when the voltage of the second battery and the voltage of the third battery are higher than the voltage of the first battery or when the remaining battery level of the second battery and the remaining battery level of the third battery are higher than the remaining battery level of the first battery, power feed from the second battery and the third battery to the first battery may occur. According to this configuration, power feed occurs from a battery higher in voltage or remaining battery level to a battery lower in voltage or remaining battery level, and hence the first apparatus, the second apparatus, and the third apparatus can continue processing while they interchange electric power.

When the second apparatus and the third apparatus are coupled to the first apparatus, in a path through which the first battery and the second battery are electrically connected to each other, a charging control circuit for power feed from the first battery to the second battery and a charging control circuit for power feed from the second battery to the first battery are not provided, and in a path through which the first battery and the third battery are electrically connected to each other, a charging control circuit for power feed from the first battery to the third battery and a charging control circuit for power feed from the third battery to the first battery are not provided. According to this configuration, there is no electric power loss in the charging control circuit.

At least one of the first power supply manager, the second power supply manager, or the third power supply manager may transmit at least one of a voltage or a temperature of the battery of the apparatus to which the first power supply manager, the second power supply manager, or the third power supply manager belongs, to at least another one of power supply managers. At least one of the first power supply manager, the second power supply manager, or the third power supply manager may cause the switch of the apparatus to which the first power supply manager, the second power supply manager, or the third power supply manager belongs, to connect or disconnect based on at least one of the voltage or the temperature of the battery obtained from one or more other power supply managers. According to this configuration, the first power supply manager, the second power supply manager, and/or the third power supply manager can determine whether or not to perform mutual power feed among batteries of the apparatuses to which they belong, based on information from other power supply manager(s).

In a first state in which the first apparatus and the second apparatus are coupled to each other, the first apparatus and the second apparatus may exchange information in a wired signal. In a second state in which the first apparatus and the second apparatus are separate from each other, the first apparatus and the second apparatus may exchange information in a wireless signal. According to this configuration, whether the first apparatus and the second apparatus are coupled to each other or separate from each other, they can perform processing while exchanging information therebetween.

Another exemplary embodiment provides a charging control device separable from another charging control device. The charging control device includes a battery, a power supply manager, a switch for connecting or disconnecting between a terminal for electrical connection to the another charging control device and the battery, in accordance with a command from the power supply manager, and a resistor provided between the battery and the terminal. When the charging control device is coupled to the another charging control device, the battery and a battery of the another charging control device are electrically connected to each other with the resistor, the switch, a switch of the another charging control device, and a resistor of the another charging control device connected in series being interposed.

The power supply manager may cause the switch to connect or disconnect based on at least one of a voltage or a temperature of the battery.

The power supply manager may transmit at least one of a voltage or a temperature of the battery to the another charging control device. The power supply manager may cause the switch to connect or disconnect based on at least one of a voltage or a temperature of the battery obtained from a power supply manager of the another charging control device.

The power supply manager may command the switch to connect when a voltage of the battery is within a predetermined voltage range.

When the charging control device is coupled to the another charging control device and second another charging control device, a battery of the second another charging control device may be connected between the switch and a switch of the another charging control device with a switch and a resistor of the second another charging control device being interposed.

In a first state in which the charging control device is coupled to the another charging control device, the charging control device and the another charging control device may exchange information with each other in a wired signal, and in a second state in which the charging control device and the another charging control device are separate, the charging control device and the another charging control device may exchange information in a wireless signal.

The foregoing and other objects, features, aspects, and advantages of the present disclosure will become more apparent from the following detailed description of the present disclosure when taken in conjunction with the accompanying drawings.

### BRIEF DESCRIPTION OF THE DRAWINGS

FIG. 1 shows an exemplary illustrative non-limiting drawing illustrating an exemplary overall configuration of a game system according to the present embodiment.

FIG. 2 shows an exemplary illustrative non-limiting drawing illustrating an exemplary form of use of a processing apparatus including a power supply circuit according to the present embodiment.

FIG. 3 shows an exemplary illustrative non-limiting drawing illustrating an exemplary form of use of the processing apparatus including the power supply circuit according to the present embodiment.

FIG. 4 shows an exemplary illustrative non-limiting drawing illustrating an exemplary internal configuration of the game system according to the present embodiment.

FIGS. 5A to 5C and 6A to 6C show exemplary illustrative non-limiting drawings for illustrating mutual power feed in the game system according to the present embodiment.

FIG. 7 shows an exemplary illustrative non-limiting drawing illustrating an exemplary configuration associated with mutual power feed in the game system according to the present embodiment.

FIGS. 8A and 8B show exemplary illustrative non-limiting drawings illustrating exemplary power feed that occurs in the exemplary configuration shown in FIG. 7.

FIG. 9 shows an exemplary illustrative non-limiting flowchart illustrating a processing procedure associated with mutual power feed in the exemplary configuration shown in FIG. 7.

FIG. 10 shows an exemplary illustrative non-limiting drawing illustrating another exemplary configuration associated with mutual power feed in the game system according to the present embodiment.

FIG. 11 shows an exemplary illustrative non-limiting flowchart illustrating a processing procedure associated with mutual power feed in the exemplary configuration shown in FIG. 10.

FIG. 12 shows an exemplary illustrative non-limiting drawing illustrating yet another exemplary configuration associated with mutual power feed in the game system according to the present embodiment.

### DETAILED DESCRIPTION OF NON-LIMITING EXAMPLE EMBODIMENTS

The present embodiment will be described in detail with reference to the drawings. The same or corresponding elements in the drawings have the same reference characters allotted and description thereof will not be repeated.

### A. Exemplary Overall Configuration

An exemplary overall configuration of a charging control system including a charging control device according to the present embodiment will initially be described. Though the charging control system according to the present embodiment is applicable to any electronic devices and systems, a game system will be described below by way of example of the charging control system. The term “game system” in the description below encompasses the “charging control system.”

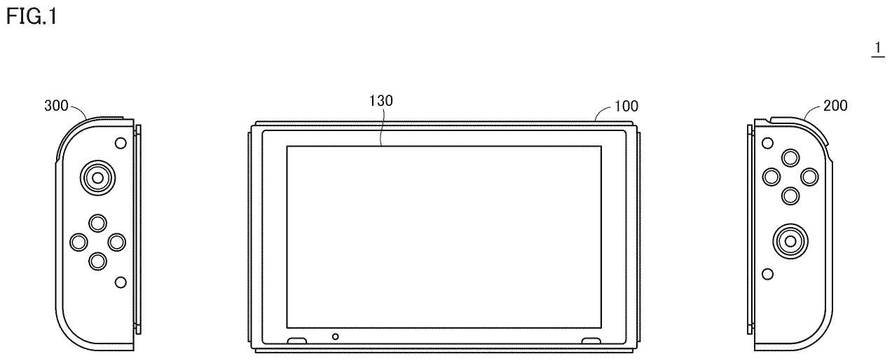

Referring to FIG. 1, a game system 1 includes a processing apparatus 100, a right controller 200, and a left controller 300. Each of processing apparatus 100, right controller 200, and left controller 300 is an exemplary “charging control device.” In the description below, processing apparatus 100, right controller 200, and left controller 300 may simply collectively be referred to as an “apparatus”.

Processing apparatus 100, right controller 200, and left controller 300 are separable from one another. Processing apparatus 100, right controller 200, and left controller 300 can directly or indirectly be coupled to one another.

Processing apparatus 100 is an electronic device that executes an application such as a game in accordance with data indicating an operation by a user from each of right controller 200 and left controller 300. Processing apparatus 100 includes a built-in display 130 that outputs an image.

Each of right controller 200 and left controller 300 receives the operation by the user. Processing apparatus 100 and right controller 200 are removably attachable to each other. Similarly, processing apparatus 100 and left controller 300 are removably attachable to each other.

Each of right controller 200 and left controller 300 exchanges data through wireless communication with processing apparatus 100 while it is separate from processing apparatus 100. Each of right controller 200 and left controller 300 exchanges data through wired communication and/or wireless communication with processing apparatus 100 while it is attached to processing apparatus 100.

Right controller 200 is thus coupled to one side of processing apparatus 100 and can transmit a signal in accordance with the operation by the user to processing apparatus 100. Left controller 300 is coupled to the other side of processing apparatus 100 and can transmit a signal in accordance with the operation by the user to processing apparatus 100.

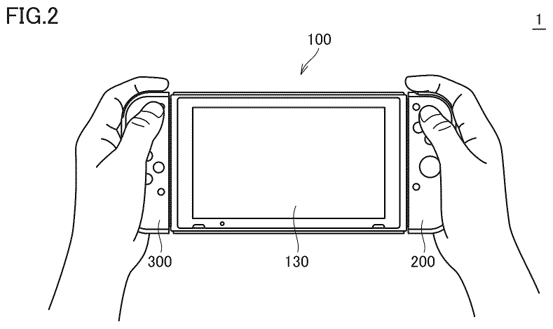

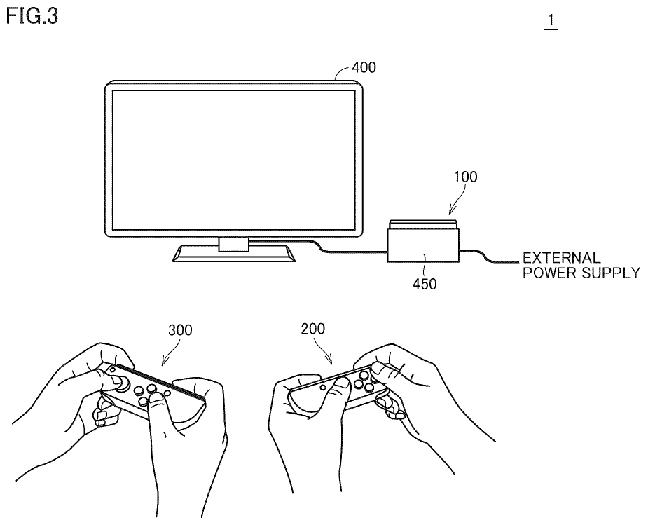

An exemplary form of use of processing apparatus 100 including a power supply circuit according to the present embodiment will now be described with reference to FIGS. 2 and 3.

Referring to FIG. 2, when right controller 200 and left controller 300 are coupled to processing apparatus 100, the user can hold and operate right controller 200 and left controller 300 integrated with processing apparatus 100.

Referring to FIG. 3, when processing apparatus 100 is placed in a dock 450, one or more users operate right controller 200 and/or left controller 300 while watching images outputted to an external monitor 400.

As shown in FIG. 2, when processing apparatus 100 is coupled to right controller 200 and left controller 300, information is exchanged in a wired signal between processing apparatus 100 and right controller 200 and between processing apparatus 100 and left controller 300. While processing apparatus 100 is separate from right controller 200 and left controller 300, on the other hand, information is exchanged in a wireless signal between processing apparatus 100 and right controller 200 and between processing apparatus 100 and left controller 300.

Information may be exchanged in a wireless signal between processing apparatus 100 and right controller 200 and/or between processing apparatus 100 and left controller 300 also in the state shown in FIG. 2.

### B. Exemplary Internal Configuration of Game System 1

An exemplary internal configuration of game system 1 according to the present embodiment will now be described.

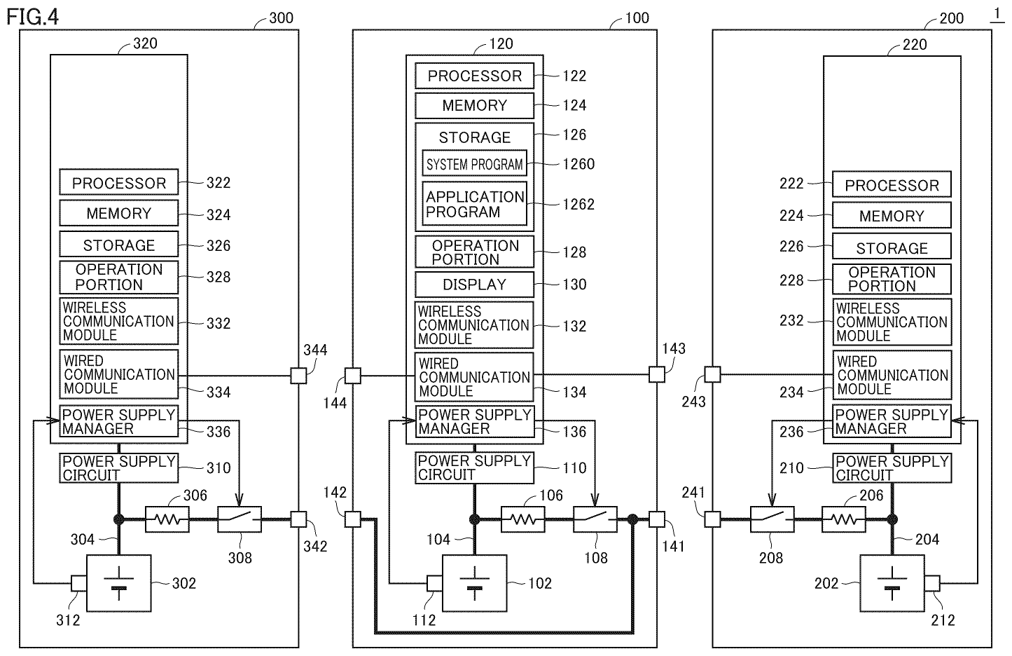

An exemplary internal configuration of processing apparatus 100, right controller 200, and left controller 300 included in game system 1 will be described with reference to FIG. 4.

Processing apparatus 100 includes a battery 102, a power supply circuit 110 electrically connected to battery 102 through a line 104, and a load circuit 120 supplied with electric power from power supply circuit 110. Right controller 200 includes a battery 202, a power supply circuit 210 electrically connected to battery 202 through a line 204, and a load circuit 220 supplied with electric power from power supply circuit 210. Left controller 300 includes a battery 302, a power supply circuit 310 electrically connected to battery 302 through a line 304, and a load circuit 320 supplied with electric power from power supply circuit 310.

Power supply circuits 110, 210, and 310 adjust voltages of electric power supplied from batteries 102, 202, and 302 to voltages suitable for operation of load circuits 120, 220, and 320, respectively.

Batteries 102, 202, and 302 are each a chargeable and dischargeable secondary battery. Any secondary battery such as a lithium ion battery, a nickel metal hydride battery, or a nickel-cadmium battery can be adopted as batteries 102, 202, and 302. Since a capacity, a rated current, a rated voltage, or the like is designed appropriately for each battery, batteries 102, 202, and 302 do not have to be identical in specifications.

Batteries 102, 202, and 302 may each be provided with a not-shown circuit for storage of electric power supplied from an external power supply (for example, a power supply adapter).

In game system 1, processing apparatus 100 (battery 102), right controller 200 (battery 202), and left controller 300 (battery 302) can mutually feed power between at least two of them or among all of them.

Load circuit 120 of processing apparatus 100 includes a processor 122, a memory 124, a storage 126, an operation portion 128, display 130, a wireless communication module 132, a wired communication module 134, and a power supply manager 136.

Processor 122 is a processing entity for performing processing provided by processing apparatus 100.

Memory 124 is a storage device accessible by processor 122, and it is implemented, for example, by a volatile storage device such as a dynamic random access memory (DRAM) or a static random access memory (SRAM).

Storage 126 is implemented, for example, by a non-volatile storage device such as a flash memory. For example, a system program 1260 and an application program 1262 are stored in storage 126.

Processor 122 performs processing as will be described later by reading a program stored in storage 126, developing the program on memory 124, and executing the program. The term “processor” herein encompasses, in addition to ordinary meaning of processing circuitry that performs processing in accordance with instruction code described in a program, such as a central processing unit (CPU), a micro processing unit (MPU), or a graphics processing unit (GPU), hard-wired circuitry such as an application specific integrated circuit (ASIC) or a field programmable gate array (FPGA). In the hard-wired circuitry such as an ASIC or an FPGA, a circuit corresponding to processing to be performed is formed in advance. Furthermore, the “processor” herein also encompasses circuitry in which a plurality of functions are integrated, such as a system on chip (SoC) and combination of the processor in a narrow sense and the hard-wired circuitry.

Operation portion 128 includes a key or a button to be operated by the user. Operation portion 128 outputs a signal in accordance with the operation by the user to processor 122.

Display 130 shows an image based on a result of processing by processor 122.

Wireless communication module 132 transmits and receives a wireless signal to or from right controller 200 and left controller 300. For example, any wireless scheme such as Bluetooth®, ZigBee®, wireless LAN (IEEE 802.11), or infrared communication can be adopted for wireless communication module 132.

Wired communication module 134 transmits and receives an electrical signal (wired signal) to and from right controller 200 and left controller 300, through a communication terminal 143 and a communication terminal 144.

Power supply manager 136 manages exchange of electric power with right controller 200 and/or left controller 300. More specifically, power supply manager 136 obtains state information such as a voltage and a temperature of battery 102 and provides a command to a switch 108. A sensor 112 for obtaining the state information of battery 102 is provided for battery 102.

Switch 108 activates/deactivates electrical connection to right controller 200 through a power terminal 141 and electrical connection to left controller 300 through a power terminal 142. In other words, switch 108 connects or disconnects battery 102 to or from power terminal 141 and power terminal 142 for electrical connection to right controller 200 and left controller 300, respectively, in accordance with a command from power supply manager 136. Switch 108 (and switches 208 and 308 which will be described later) may include a mechanical opening and closing mechanism or may switch a conducting state of a semiconductor or the like.

A resistor 106 is provided between battery 102 and switch 108. A resistance value of resistor 106 is determined in accordance with a value of an allowable current suppliable from battery 102 to right controller 200 and/or left controller 300 (for example, approximately 1 Ω).

Load circuit 220 of right controller 200 includes a processor 222, a memory 224, a storage 226, an operation portion 228, a wireless communication module 232, a wired communication module 234, and a power supply manager 236.

Processor 222 is a processing entity for performing processing provided by right controller 200. Processor 222 performs processing necessary for right controller 200 by reading a program stored in storage 226, developing the program on memory 224, and executing the program.

Operation portion 228 outputs a signal in accordance with the operation by the user to processor 222. Details of the operation by the user are transmitted to processing apparatus 100 as a wireless signal or a wired signal.

Wireless communication module 232 transmits and receives a wireless signal to and from processing apparatus 100. Wired communication module 234 transmits and receives an electrical signal (wired signal) to and from processing apparatus 100 through a communication terminal 243.

Power supply manager 236 manages exchange of electric power with processing apparatus 100 and/or left controller 300. M ore specifically, power supply manager 236 obtains state information such as a voltage and a temperature of battery 202 and provides a command to a switch 208. A sensor 212 for obtaining the state information of battery 202 is provided for battery 202.

Switch 208 activates/deactivates electrical connection to processing apparatus 100 (and left controller 300) through a power terminal 241. In other words, switch 208 connects or disconnects battery 202 to or from power terminal 241 for electrical connection to processing apparatus 100 (and left controller 300), in accordance with a command from power supply manager 236.

A resistor 206 is provided between battery 202 and switch 208. A resistance value of resistor 206 is determined in accordance with a value of an allowable current suppliable from battery 202 to processing apparatus 100 and/or left controller 300.

Load circuit 320 of left controller 300 includes a processor 322, a memory 324, a storage 326, an operation portion 328, a wireless communication module 332, a wired communication module 334, and a power supply manager 336. Wired communication module 334 transmits and receives a wired signal to and from processing apparatus 100 through a communication terminal 344. Since a configuration and a function of each component are similar to those in load circuit 220 of right controller 200, detailed description will not be repeated.

A switch 308 activates/deactivates electrical connection to processing apparatus 100 (and right controller 200) through a power terminal 342. In other words, switch 308 connects or disconnects battery 302 to or from power terminal 342 for electrical connection to processing apparatus 100 (and right controller 200), in accordance with a command from power supply manager 336.

A resistor 306 is provided between battery 302 and switch 308. A resistance value of resistor 306 is determined in accordance with a value of an allowable current suppliable from battery 302 to processing apparatus 100 and/or right controller 200.

A sensor 312 for obtaining state information such as a voltage and a temperature of battery 302 is provided for battery 302.

### C. Mutual Power Feed

Mutual power feed in game system 1 according to the present embodiment will now be described.

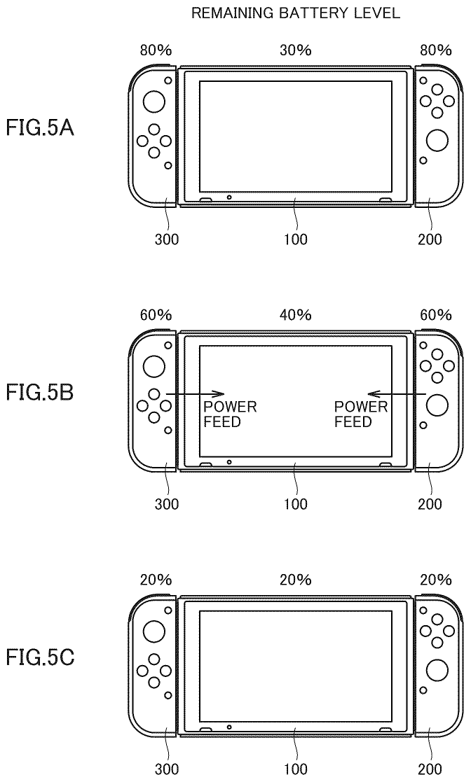

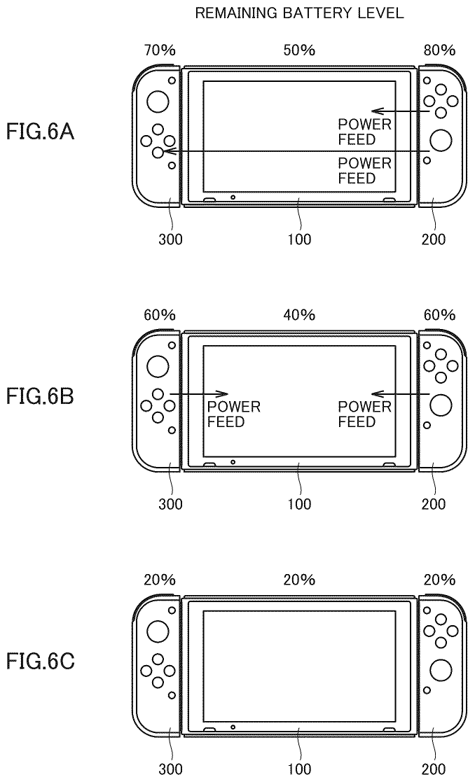

Mutual power feed in game system 1 according to the present embodiment will be described with reference to FIGS. 5A to 5C and 6A to 6C. It is assumed that electric power from an external power supply is not supplied.

Referring to FIG. 5A, it is assumed, for example, that a remaining battery level of processing apparatus 100 is 30%, a remaining battery level of right controller 200 is 80%, and a remaining battery level of left controller 300 is 80%. The remaining battery level herein mainly means a state of charge (SOC) which is an indicator indicating a rate of charging or a charged state. In other words, the remaining battery level represents how much electric power is stored with respect to a full charge capacity of each battery.

When each apparatus operates only with electric power from its own battery, the remaining battery level of processing apparatus 100 reaches a lower limit value (for example, 20%) first, and game system 1 becomes unable to operate. When the remaining battery level of right controller 200 and/or left controller 300 has not reached the lower limit value, however, processing apparatus 100 can operate by using electric power stored in the batteries of these controllers.

In game system 1 according to the present embodiment, processing apparatus 100, right controller 200, and left controller 300 can mutually feed power.

FIG. 5B shows a state in which right controller 200 and left controller 300 feed power to processing apparatus 100 by way of example. When electric power supplied to processing apparatus 100 is higher than electric power used in processing apparatus 100, the remaining battery level of processing apparatus 100 increases. As a result of such mutual power feed, the remaining battery level of game system 1 as a whole can be leveled. In other words, a plurality of batteries of game system 1 can be used in a unified manner so to speak.

Consequently, as shown in FIG. 5C, substantially all electric power stored in the batteries can be used, so that game system 1 can operate for a longer time period.

FIG. 5B shows the state in which right controller 200 and left controller 300 feed power to processing apparatus 100 by way of example. In this state, the remaining battery levels of battery 202 of right controller 200 and battery 302 of left controller 300 are higher than the remaining battery level of battery 102 of processing apparatus 100. At this time, the voltages of battery 202 and battery 302 are higher than the voltage of battery 102. Depending on such relative relation of the voltage or the remaining battery level, power feed from battery 202 and battery 302 to battery 102 occurs.

In addition to power feed shown in FIG. 5B, at least power feed shown below can be performed.

(1) Power feed from processing apparatus 100 to right controller 200 and left controller 300

(2) Power feed from processing apparatus 100 to right controller 200

(3) Power feed from processing apparatus 100 to left controller 300

(4) Power feed from right controller 200 to processing apparatus 100 and left controller 300

(5) Power feed from right controller 200 to processing apparatus 100

(6) Power feed from right controller 200 to left controller 300

(7) Power feed from left controller 300 to processing apparatus 100 and right controller 200

(8) Power feed from left controller 300 to processing apparatus 100

(9) Power feed from left controller 300 to right controller 200

For example, power feed shown in (1) may occur when the remaining battery level of battery 102 is higher than the remaining battery levels of battery 202 and battery 302. At this time, the voltage of battery 102 is higher than the voltages of battery 202 and battery 302. Depending on such relative relation of the voltage or the remaining battery level, power feed from battery 102 to battery 202 and battery 302 occurs.

As shown in FIG. 6A, when right controller 200 is higher (for example, 80%) in remaining battery level than processing apparatus 100 and left controller 300, each apparatus performs processing while right controller 200 feeds power to processing apparatus 100 and left controller 300.

Thereafter, when right controller 200 and left controller 300 are substantially equal in remaining battery level to each other (that is, a voltage difference between right controller 200 and left controller 300 becomes substantially zero), as shown in FIG. 6B, right controller 200 and left controller 300 feed power to processing apparatus 100.

As such power feed is naturally performed, as shown in FIG. 6C, substantially all electric power stored in the batteries can fully be used.

### D. Processing Procedure

A processing procedure in mutual power feed in game system 1 according to the present embodiment will now be described.

### (d1: Mutual Power Feed Between Two Apparatuses)

For simplification of description, exemplary mutual power feed between two apparatuses (processing apparatus 100 and right controller 200) is initially shown. Description below is applicable to combination of any two of processing apparatus 100, right controller 200, and left controller 300.

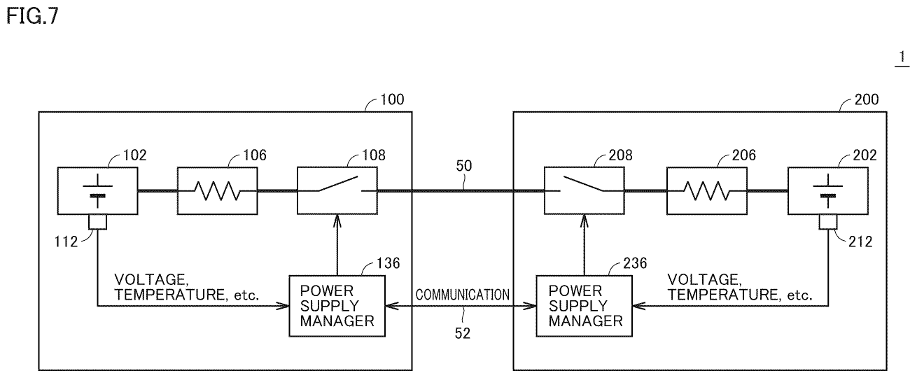

An exemplary configuration associated with mutual power feed in game system 1 according to the present embodiment will be described with reference to FIG. 7. FIG. 7 shows a state in which processing apparatus 100 and right controller 200 are coupled to each other.

A power supply path 50 between switch 108 of processing apparatus 100 and switch 208 of right controller 200 includes power terminal 141 of processing apparatus 100 and power terminal 241 of right controller 200.

As processing apparatus 100 and right controller 200 are thus coupled to each other, battery 102 and battery 202 are electrically connected to each other with resistor 106, switch 108, switch 208, and resistor 206 connected in series being interposed. As shown in FIG. 7, when processing apparatus 100 and right controller 200 are coupled to each other, in the path through which battery 102 and battery 202 are electrically connected to each other, a charging control circuit for power feed from battery 102 to battery 202 and a charging control circuit for power feed from battery 202 to battery 102 are not provided.

Consequently, when switch 108 and switch 208 are closed, a current in accordance with a voltage difference between battery 102 and battery 202 and resistance values of resistor 106 and resistor 206 flows between battery 102 and battery 202.

Power supply manager 136 of processing apparatus 100 and power supply manager 236 of right controller 200 can communicate with each other. A communication path 52 includes communication terminal 143 of processing apparatus 100 and communication terminal 243 of right controller 200. Communication processing may be performed through wired communication module 134 and wired communication module 234 (FIG. 4).

Power supply manager 136 determines whether or not mutual power feed can be performed based on the state information (the voltage, the temperature, etc.) of battery 102 and information obtained from power supply manager 236. When power supply manager 136 determines that mutual power feed can be performed, it has switch 108 closed. As switch 108 is closed, power feed from battery 102 to another apparatus and/or power reception from another apparatus to battery 102 can be performed.

Similarly, power supply manager 236 determines whether or not mutual power feed can be performed based on the state information (the voltage, the temperature, etc.) of battery 202 and information obtained from power supply manager 136. When power supply manager 236 determines that mutual power feed can be performed, it has switch 208 closed. As switch 208 is closed, power feed from battery 202 to another apparatus and/or power reception from another apparatus to battery 202 can be performed.

Power supply manager 136 thus causes switch 108 to connect or disconnect based on at least one of the voltage or the temperature of battery 102. Similarly, power supply manager 236 causes switch 208 to connect or disconnect based on at least one of the voltage or the temperature of battery 202.

Furthermore, when power supply manager 136 and/or power supply manager 236 is/are able to transmit at least one of the voltage or the temperature of the battery of the apparatus to which it belongs to the other of the power supply managers as shown in FIG. 7, the power supply manager as a destination may cause the switch of the apparatus to which it belongs to connect or disconnect based on at least one of the obtained voltage or temperature of the battery. Both of power supply manager 136 and power supply manager 236 do not have to be able to transmit the state information (the voltage, the temperature, etc.) of the battery to the other of the power supply managers. In other words, only one of the power supply managers may be able to transmit the state information of the battery.

In game system 1 according to the present embodiment, power feed (naturally) occurs in accordance with a difference in voltage or remaining battery level of the battery. In other words, power feed from the first battery to the second battery or power feed from the second battery to the first battery occurs in accordance with the state of the voltage or the remaining battery level of each battery.

Exemplary power feed that occurs in the exemplary configuration shown in FIG. 7 will now be described.

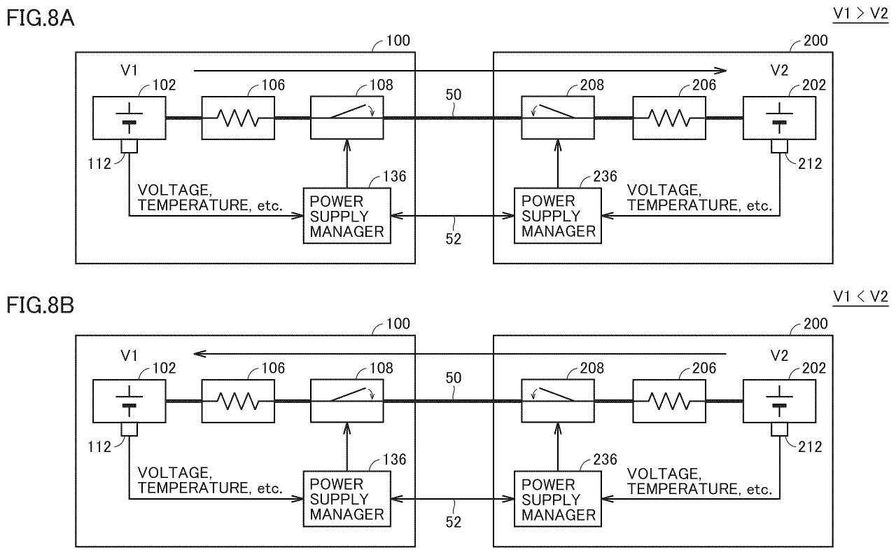

As shown in FIG. 8A, when a voltage V1 of battery 102 is higher than a voltage V2 of battery 202, power feed from battery 102 to battery 202 occurs. Alternatively, as shown in FIG. 8B, when voltage V2 of battery 202 is higher than voltage V1 of battery 102, power feed from battery 202 to battery 102 occurs. Similar power feed may occur also depending on relation of magnitude of the remaining battery level.

When battery 102 is higher in voltage or remaining battery level than battery 202, power feed from battery 102 to battery 202 occurs. When battery 202 is higher in voltage or remaining battery level than battery 102, power feed from battery 202 to battery 102 occurs.

In mutual power feed between battery 102 and battery 202, a current flows through resistor 106 and resistor 206 connected in series. By designing resistance values of resistors 106 and 206 to appropriate values, an excessively large current can be prevented from flowing between batteries while a simplified circuit configuration is maintained.

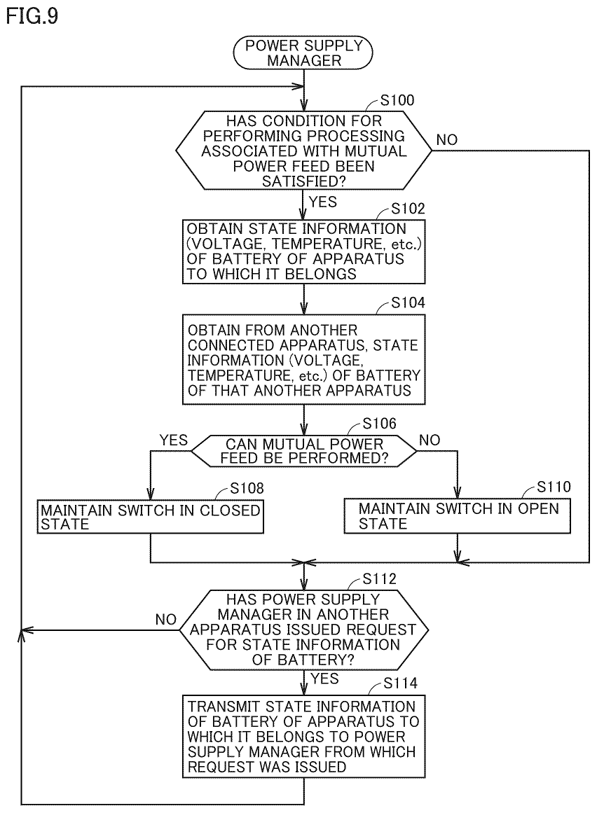

An exemplary processing procedure associated with mutual power feed in the exemplary configuration shown in FIG. 7 will be described with reference to FIG. 9 Each step shown in FIG. 9 is performed by the power supply manager of each apparatus. The power supply manager does not have to perform all processing but the processor may perform some processing.

The power supply manager of each apparatus determines whether or not a condition for performing processing associated with mutual power feed has been satisfied (step S100). The condition for performing the processing associated with mutual power feed may include, for example, electrical connection of an apparatus to which a power supply manager belongs to another apparatus and lapse of a predetermined time period since previous determination processing.

When the condition for performing the processing associated with mutual power feed has been satisfied (YES in step S100), the power supply manager obtains the state information (the voltage, the temperature, etc.) of the battery of the apparatus to which it belongs (step S102) and obtains from another connected apparatus, the state information (the voltage, the temperature, etc.) of the battery of that another apparatus (step S104).

The power supply manager determines whether or not mutual power feed can be performed based on the state information of the battery of the apparatus to which it belongs and the state information of the battery of another apparatus (step S106). When mutual power feed can be performed (YES in step S106), the power supply manager maintains the switch in the closed state (step S108). When mutual power feed cannot be performed (NO in step S106), the power supply manager maintains the switch in the open state (step S110).

When the condition for performing the processing associated with mutual power feed has not been satisfied (NO in step S100), processing in steps S102 to S110 is skipped.

In succession, the power supply manager determines whether or not the power supply manager of another apparatus has issued a request for the state information of the battery (step S112). When the power supply manager of another apparatus has issued the request for the state information of the battery (YES in step S112), the power supply manager transmits the state information of the battery of the apparatus to which it belongs to the power supply manager from which the request was issued (step S114).

When the power supply manager of another apparatus has not issued the request for the state information of the battery (NO in step S112), processing in step S114 is skipped.

Thereafter, processing in step S100 or later is repeated.

The condition that enables mutual power feed described above (step S106) can be set, for example, by combining one or more of conditions below as appropriate.
The voltage of the battery of a certain apparatus being within a predetermined voltage range (or the voltage of the battery of the certain apparatus being not larger than the predetermined upper limit value)
The voltage of the battery of another apparatus being within a predetermined voltage range (or the voltage of the battery of another apparatus being not larger than the predetermined upper limit value)
A difference between the voltage of the battery of a certain apparatus and the voltage of the battery of another apparatus being within a predetermined range
The temperature of the battery of a certain apparatus being within a predetermined temperature range (for example, a room temperature)
The temperature of the battery of another apparatus being within a predetermined temperature range (for example, a room temperature)

Furthermore, the remaining battery level, power consumption in the load circuit, whether or not there is supply from an external power supply, or the like may be included in the condition that enables mutual power feed.

When the remaining battery level is lowering, it may be determined that the condition that enables mutual power feed is no longer satisfied before the remaining battery level reaches a predetermined lower limit value. In other words, before electric power stored in the battery is fully used, the switch may be opened to electrically disconnect the battery from another battery.

### (d2: Mutual Power Feed Between Two Apparatuses: Without Communication)

In the exemplary configuration for mutual power feed described above, whether or not mutual power feed can be performed is determined by communication by the power supply manager with another power supply manager. In game system 1 according to the present embodiment, each apparatus may determine whether or not mutual power feed can be performed without communication by the power supply manager with another power supply manager.

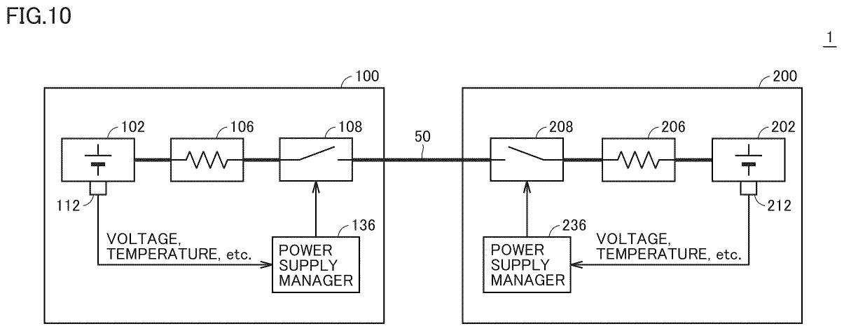

FIG. 10 is a schematic diagram showing another exemplary configuration associated with mutual power feed in game system 1 according to the present embodiment. In the exemplary configuration shown in FIG. 10, as compared with the exemplary configuration shown in FIG. 7, communication path 52 between power supply manager 136 of processing apparatus 100 and power supply manager 236 of right controller 200 has been removed.

Each of power supply manager 136 of processing apparatus 100 and power supply manager 236 of right controller 200 determines whether or not mutual power feed can be performed based on the information obtained from the apparatus to which it belongs. When mutual power feed can be performed, the switch is maintained in the closed state.

When mutual power feed can be performed in one of the apparatuses and mutual power feed cannot be performed in the other of the apparatuses, the batteries are not electrically connected to each other and hence mutual power feed is substantially not started. In other words, mutual power feed is started only when it is determined that mutual power feed can be performed in both of the two apparatuses.

Therefore, appropriate control can be achieved even when the power supply manager of each apparatus determines whether or not mutual power feed can be performed based only on information obtained from each apparatus to which it belongs.

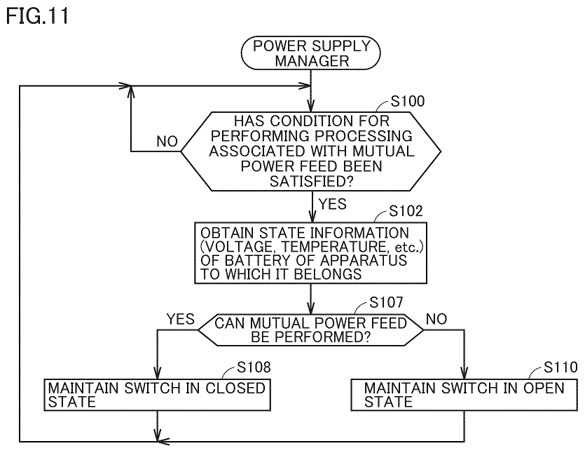

An exemplary processing procedure associated with mutual power feed in the exemplary configuration shown in FIG. 10 will be described with reference to FIG. 11. Each step shown in FIG. 11 is performed by the power supply manager of each apparatus. The power supply manager does not have to perform all processing but the processor may perform some processing. Processing in FIG. 11 substantially identical to that in the steps shown in FIG. 9 has the same step number allotted.

The power supply manager of each apparatus determines whether or not the condition for performing processing associated with mutual power feed has been satisfied (step S100). The condition for performing the processing associated with mutual power feed may include, for example, electrical connection of an apparatus to which a power supply manager belongs to another apparatus and lapse of a predetermined time period since previous determination processing.

When the condition for performing the processing associated with mutual power feed has been satisfied (YES in step S100), the power supply manager obtains the state information (the voltage, the temperature, etc.) of the battery of the apparatus to which it belongs (step S102).

The power supply manager determines whether or not mutual power feed can be performed based on the state information of the battery of the apparatus to which it belongs (step S107). When mutual power feed can be performed (YES in step S107), the power supply manager maintains the switch in the closed state (step S108). When mutual power feed cannot be performed (NO in step S107), the power supply manager maintains the switch in the open state (step S110).

When the condition for performing the processing associated with mutual power feed has not been satisfied (NO in step S100), the processing in steps S102 to S110 is skipped.

Thereafter, processing in step S100 or later is repeated.

In the exemplary configuration shown in FIG. 10, the condition that enables mutual power feed (step S107) can be set, for example, by combining one or more of conditions below as appropriate.
The voltage of the battery of a certain apparatus being within a predetermined voltage range
The temperature of the battery of a certain apparatus being within a predetermined temperature range

Furthermore, the remaining battery level, power consumption in the load circuit, whether or not there is supply from an external power supply, or the like may be included in the condition that enables mutual power feed.

### (d3: Mutual Power Feed Among Three Apparatuses)

Three apparatuses (processing apparatus 100, right controller 200, and left controller 300) included in game system 1 according to the present embodiment can also mutually feed power.

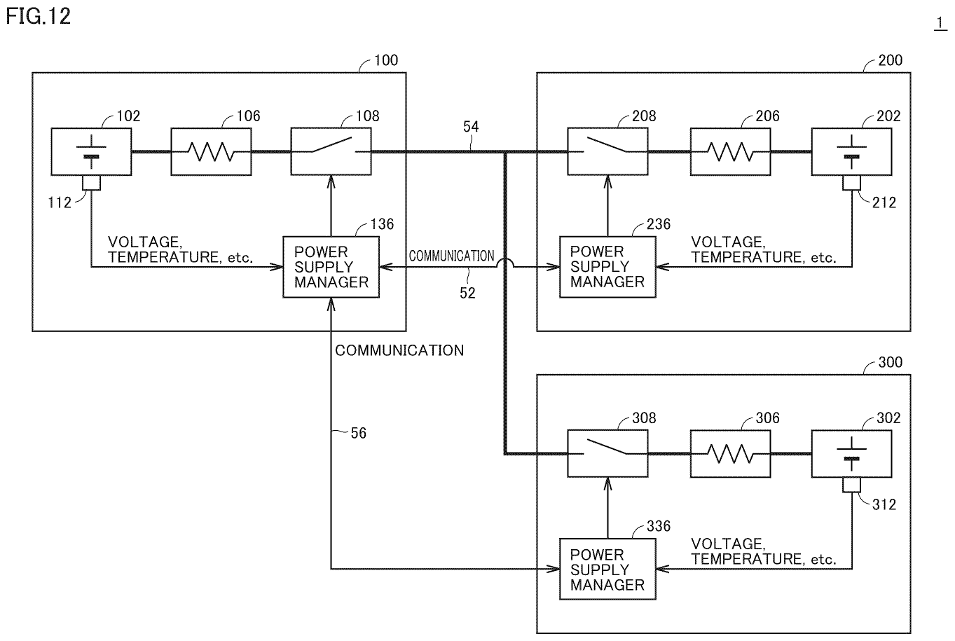

Yet another exemplary configuration associated with mutual power feed in game system 1 according to the present embodiment will be described with reference to FIG. 12. FIG. 12 shows a state in which processing apparatus 100, right controller 200, and left controller 300 are coupled to one another.

Switch 108 of processing apparatus 100, switch 208 of right controller 200, and switch 308 of left controller 300 are electrically connected to one another through a power supply path 54. Power supply path 54 includes power terminal 141 of processing apparatus 100, power terminal 241 of right controller 200, and power terminal 342 of left controller 300.

Power feed among battery 102, battery 202, and battery 302 occurs in accordance with the voltages or the remaining battery levels of battery 102, battery 202, and battery 302.

A s processing apparatus 100, right controller 200, and left controller 300 are thus coupled to one another, battery 302 is connected between switch 108 and switch 208 with switch 308 and resistor 306 being interposed. As shown in FIG. 12, in a state in which processing apparatus 100 is coupled to right controller 200 and left controller 300, in a path through which battery 102 and battery 202 are electrically connected to each other, a charging control circuit for power feed from battery 102 to battery 202 and a charging control circuit for power feed from battery 202 to battery 102 are not provided. Similarly, in a path through which battery 102 and battery 302 are electrically connected to each other, a charging control circuit for power feed from battery 102 to battery 302 and a charging control circuit for power feed from battery 302 to battery 102 are not provided.

Power supply manager 136 of processing apparatus 100 and power supply manager 236 of right controller 200 can communicate with each other, and power supply manager 136 of processing apparatus 100 and power supply manager 336 of left controller 300 can communicate with each other. Communication path 52 includes communication terminal 143 of processing apparatus 100 and communication terminal 243 of right controller 200. A communication path 56 includes communication terminal 143 of processing apparatus 100 and communication terminal 344 of left controller 300.

Power supply manager 136 determines whether or not mutual power feed can be performed based on the state information (the voltage, the temperature, etc.) of battery 102, the information obtained from power supply manager 236, and the information obtained from power supply manager 336. Similarly, power supply manager 236 determines whether or not mutual power feed can be performed based on the state information (the voltage, the temperature, etc.) of battery 202, the information obtained from power supply manager 136, and the information obtained from power supply manager 336. Similarly, power supply manager 336 determines whether or not mutual power feed can be performed based on the state information (the voltage, the temperature, etc.) of battery 302, the information obtained from power supply manager 136, and the information obtained from power supply manager 236.

When power supply managers 136, 236, and 336 determine that mutual power feed can be performed, they have switches 108, 208, and 308 closed, respectively. When at least two switches are closed, mutual power feed is performed.

As shown in FIG. 12, when at least one of power supply manager 136, power supply manager 236, or power supply manager 336 can transmit at least one of the voltage or the temperature of the battery of the apparatus to which it belongs to other power supply manager(s), the power supply manager(s) as the destination may cause the switch(es) of the apparatus(es) to which it (they) belong(s) to connect or disconnect based on at least one of the obtained voltage or temperature of the battery. All of power supply manager 136, power supply manager 236, and power supply manager 336 do not have to be able to transmit the state information (the voltage, the temperature, etc.) of the battery to other power supply managers. In other words, only at least one power supply manager may be able to transmit the state information of the battery.

In game system 1 according to the present embodiment, power feed in accordance with the difference in voltage or remaining battery level of the battery occurs. In other words, power feed from one or more batteries relatively high in voltage among electrically connected batteries to one or more batteries relatively low in voltage occurs.

### (d4: Mutual Power Feed Among Three Apparatuses: Without Communication)

A communication path among the power supply managers may be removed also from the exemplary configuration shown in FIG. 12, as in the exemplary configuration shown in FIG. 10. When it is determined that mutual power feed can be performed in at least two apparatuses as described above, mutual power feed is started.

### (d5: Mutual Power Feed Among More Than Three Apparatuses)

Though mutual power feed between two apparatuses or among three apparatuses is described in the exemplary configurations above, more apparatuses may electrically be connected to one another to perform mutual power feed.

In the game system according to the present embodiment, power feed in accordance with the voltage or the remaining battery level of the battery of each apparatus occurs, and hence complicated control is not required. Therefore, the number of apparatuses to electrically be connected is not particularly restricted.

### E. Modification

Even when at least one electrically connected battery is being charged with electric power from an external power supply, mutual power feed with another battery can be performed. In this case, at least one of electric power stored in the battery or electric power supplied from the external power supply is supplied to another battery.

Though right controller 200 and left controller 300 can be coupled to processing apparatus 100 in the exemplary configurations described above, without being limited as such, right controller 200 and left controller 300 may be configured to be coupled to each other. In this case, mutual power feed between right controller 200 and left controller 300 can be performed.

### F. Advantage

According to the present embodiment, when the condition that enables mutual power feed is satisfied when a plurality of physically separable apparatuses are physically coupled to each other, batteries are electrically connected to each other. Since power feed in accordance with the voltage or the remaining battery level occurs between/among the batteries, electric power stored in the batteries is fully used in the system as a whole and the system can operate for a longer time period.

According to the present embodiment, electric power and the current do not have to be adjusted with the charging control circuit such as the charging control IC and hence there is no conversion loss. Therefore, efficiency in power feed can be enhanced. Since power feed occurs in accordance with the difference in voltage or remaining battery level of the battery, necessity for processing for determining a power feed side and a power reception side, processing for determining a voltage for power feed, or the like can be obviated. Furthermore, according to the present embodiment, since the number of electrically connectable batteries is not restricted, a plurality of apparatuses can also feed power to a single apparatus.

Mutual power feed according to the present embodiment aims at operation of the system for a longer time period by fully using electric power stored in a plurality of batteries, and a rate of power feed (wattage) does not have to excessively be increased.

Although the present disclosure has been described and illustrated in detail, it is clearly understood that the same is by way of illustration and example only and is not to be taken by way of illustration, the scope of the present disclosure being interpreted by the terms of the appended claims.

What is claimed is:

1. A charging control system comprising:
a first apparatus and a second apparatus separable from each other, wherein
the first apparatus comprises
a first battery,
a first power supply manager,
a first switch for connecting or disconnecting between a first terminal for electrical connection to the second apparatus and the first battery, in accordance with a command from the first power supply manager, and
a first resistor provided between the first battery and the first terminal,
the second apparatus comprises
a second battery,
a second power supply manager,
a second switch for connecting or disconnecting between a second terminal for electrical connection to the first apparatus and the second battery, in accordance with a command from the second power supply manager, and
a second resistor provided between the second battery and the second terminal, and
when the first apparatus and the second apparatus are coupled to each other, the first battery and the second battery are electrically connected to each other with the first resistor, the first switch, the second switch, and the second resistor connected in series being interposed.

2. The charging control system according to claim 1, wherein
power feed from the first battery to the second battery or power feed from the second battery to the first battery occurs in accordance with at least one of (i) a voltage of the first battery and a voltage of the second battery or (ii) a remaining battery level of the first battery and a remaining battery level of the second battery.

3. The charging control system according to claim 2, wherein
at least one of when the voltage of the first battery is higher than the voltage of the second battery or when the remaining battery level of the first battery is higher than the remaining battery level of the second battery, power feed from the first battery to the second battery occurs, and
at least one of when the voltage of the second battery is higher than the voltage of the first battery or when the remaining battery level of the second battery is higher than the remaining battery level of the first battery, power feed from the second battery to the first battery occurs.

4. The charging control system according to claim 2, wherein
when the first apparatus and the second apparatus are coupled to each other, in a path through which the first battery and the second battery are electrically connected to each other, a charging control circuit for power feed from the first battery to the second battery and a charging control circuit for power feed from the second battery to the first battery are not provided.

5. The charging control system according to claim 1, wherein
the first power supply manager is configured to cause the first switch to connect or disconnect based on at least one of a voltage or a temperature of the first battery, and
the second power supply manager is configured to cause the second switch to connect or disconnect based on at least one of a voltage or a temperature of the second battery.

6. The charging control system according to claim 1, wherein
at least one of the first power supply manager or the second power supply manager is configured to transmit at least one of a voltage or a temperature of the battery of the apparatus to which the first power supply manager or the second power supply manager belongs to another one of the first power supply manager and the second power supply manager, and
at least one of the first power supply manager or the second power supply manager is configured to cause the switch of the apparatus to which the first power supply manager or the second power supply manager belongs to connect or disconnect based on at least one of the voltage or the temperature of the battery obtained from the another one of the first power supply manager and the second power supply manager.

7. The charging control system according to claim 1, wherein
the first power supply manager is configured to command the first switch to connect when a voltage of the first battery is within a predetermined voltage range, and
the second power supply manager is configured to command the second switch to connect when a voltage of the second battery is within a predetermined voltage range.

8. The charging control system according to claim 1, further comprising a third apparatus configured to be coupled to at least one of the first apparatus or the second apparatus, wherein
the third apparatus comprises
a third battery,
a third power supply manager,
a third switch for connecting or disconnecting between a third terminal for electrical connection to at least one of the first apparatus or the second apparatus and the third battery, in accordance with a command from the third power supply manager, and
a third resistor provided between the third battery and the first terminal, and
when the first apparatus, the second apparatus, and the third apparatus are coupled to one another, the third battery is connected between the first switch and the second switch, with the third switch and the third resistor being interposed.

9. The charging control system according to claim 8, wherein
power feed occurs among the first battery, the second battery, and the third battery in accordance with at least one of (i) a voltage of the first battery, a voltage of the second battery, and a voltage of the third battery or (ii) a remaining battery level of the first battery, a remaining battery level of the second battery, and a remaining battery level of the third battery.

10. The charging control system according to claim 8, wherein
the first apparatus is an electronic device comprising a display,
the second apparatus is a controller to be coupled to one side of the first apparatus and configured to transmit a signal in accordance with an operation by a user to the first apparatus,
the third apparatus is a controller to be coupled to the other side of the first apparatus and configured to transmit a signal in accordance with an operation by the user to the first apparatus,
at least one of when a voltage of the first battery is higher than a voltage of the second battery and a voltage of the third battery or when a remaining battery level of the first battery is higher than a remaining battery level of the second battery and a remaining battery level of the third battery, power feed from the first battery to the second battery and the third battery occurs, and
at least one of when the voltage of the second battery and the voltage of the third battery are higher than the voltage of the first battery or when the remaining battery level of the second battery and the remaining battery level of the third battery are higher than the remaining battery level of the first battery, power feed from the second battery and the third battery to the first battery occurs.

11. The charging control system according to claim 10, wherein
when the second apparatus and the third apparatus are coupled to the first apparatus,
in a path through which the first battery and the second battery are electrically connected to each other, a charging control circuit for power feed from the first battery to the second battery and a charging control circuit for power feed from the second battery to the first battery are not provided, and
in a path through which the first battery and the third battery are electrically connected to each other, a charging control circuit for power feed from the first battery to the third battery and a charging control circuit for power feed from the third battery to the first battery are not provided.

12. The charging control system according to claim 8, wherein
at least one of the first power supply manager, the second power supply manager, or the third power supply manager is configured to transmit at least one of a voltage or a temperature of the battery of the apparatus to which the first power supply manager, the second power supply manager, or the third power supply manager belongs to at least another one of power supply managers, and
at least one of the first power supply manager, the second power supply manager, or the third power supply manager is configured to cause the switch of the apparatus to which the first power supply manager, the second power supply manager, or the third power supply manager belongs to connect or disconnect based on at least one of the voltage or the temperature of the battery obtained from one or more other power supply managers.

13. The charging control system according to claim 1, wherein
the first apparatus and the second apparatus are configured to exchange information in a wired signal in a first state in which the first apparatus and the second apparatus are coupled to each other, and
the first apparatus and the second apparatus are configured to exchange information in a wireless signal in a second state in which the first apparatus and the second apparatus are separate from each other.

14. A charging control device separable from another charging control device,
the charging control device comprising:
a battery;
a power supply manager;
a switch for connecting or disconnecting between a terminal for electrical connection to the another charging control device and the battery, in accordance with a command from the power supply manager; and
a resistor provided between the battery and the terminal, wherein
when the charging control device is coupled to the another charging control device, the battery and a battery of the another charging control device are electrically connected to each other with the resistor, the switch, a switch of the another charging control device, and a resistor of the another charging control device connected in series being interposed.

15. The charging control device according to claim 14, wherein
the power supply manager is configured to cause the switch to connect or disconnect based on at least one of a voltage or a temperature of the battery.

16. The charging control device according to claim 14, wherein
the power supply manager is configured to transmit at least one of a voltage or a temperature of the battery to the another charging control device, and
the power supply manager is configured to cause the switch to connect or disconnect based on at least one of a voltage or a temperature of the battery obtained from a power supply manager of the another charging control device.

17. The charging control device according to claim 14, wherein
the power supply manager is configured to command the switch to connect when a voltage of the battery is within a predetermined voltage range.

18. The charging control device according to claim 14, wherein
when the charging control device is coupled to the another charging control device and second another charging control device, a battery of the second another charging control device is connected between the switch and a switch of the another charging control device with a switch and a resistor of the second another charging control device being interposed.

19. The charging control device according to claim 14, wherein
the charging control device and the another charging control device are configured to exchange information with each other in a wired signal in a first state in which the charging control device is coupled to the another charging control device, and
the charging control device and the another charging control device are configured to exchange information in a wireless signal in a second state in which the charging control device and the another charging control device are separate.
